(19) United States
(12) Patent Application Publication
(10) Pub. No.: US 2007/0272776 A1
(43) Pub. Date: Nov. 29, 2007

(54) Method and Apparatus for Processing Excavated Earth

(76) Inventor: Jurgen Schenk, Stuttgart (DE)

Correspondence Address: VENABLE LLP, P.O. BOX 34385, WASHINGTON, DC, 20043-9998, US

(21) Appl. No.: 10/556,676

(22) PCT Filed: May 13, 2004
(86) PCT No.: PCT/EP04/05146

§ 371 Date: Dec. 4, 2006

(30) Foreign Application Priority Data
May 14, 2003 (DE) 103218327
Aug. 16, 2003 (DE) 103375902

(51) Int. Cl. B02C 23/08; B02C 17/20

(52) U.S. Cl. 241/24.1; 241/184

(57) ABSTRACT

According to the invention, a grinding operation is used to process excavated earth, excavated material, or any other mineral material of an indeterminate shape which is to be reused at a construction site. In the process, the excavated material as well as additional piece-type coarse material passes through the grinding machine. The powdered rock resulting from the comminuting of coarse material by means of suitable breaking and/or crushing operations is then used as additive for the excavated material, which is so-to-speak generated on location. This additive is suitable for regulating the moisture of the excavated earth as well as to cause a stabilization and hardening of same. The degree of drying and hardening can be adjusted through selecting the degree of grinding, for example by grinding the coarse components more or less fine, depending on the degree of moisture or the desired post-hardening. In addition, coarse components such as asphalt, construction waste material, concrete chunks, or natural stones can also be added to the excavated earth to generate the desired amounts of powdered rock during the comminuting operation.

The invention relates to a method for processing excavated material, such as mud, waste material, or other types of material containing interfering substances, as well as an apparatus for realizing this method.

German Utility Patent 202 14 956 discloses a comminuting apparatus with two counter-rotating shafts on which crusher plates are mounted. The comminuting apparatus is suitable, for example, for crushing mineral materials such as excavated earth, coarse gravel, rocks or other types of material. A fine-grain comminuting is possible, wherein grain sizes of 10 mm to 60 mm can be achieved.

Furthermore known from German Patent 101 11 305 A1 is an apparatus for processing mineral material, in particular excavated earth, which can also contain coarse-grained, brittle components. A splitting tool is used for the comminuting operation, which comprises two counter-rotating shafts with tapered chisels positioned thereon. These chisels are designed to break up the coarse components for a comminuting, wherein this can occur in the presence of cohesive material, such as clay-containing or loam-containing material. The coarse components are comminuted to a grain size of approximately 60 mm, wherein the share of powdery and fine-grained material is low.

As a result of the comminuting of the coarse components, the material generated in this way is basically suitable for reuse, e.g. for filling in excavated areas in the ground, such as ditches or pits. However, an additive such as cement, ash, powdered rock, granulate, fibers, wood shavings, wood flour, and suspensions such as lime suspensions, bentonites, or dense suspensions must be added to this material.

Starting with this premise, it is the object of the present invention to specify an improved processing method.

This object is solved with the method as defined in claim 1:

The material of an indeterminate shape which is to be processed is subjected to a comminuting process, for example if coarse material pieces are present, in which the coarse material is at least partially comminuted and mixed with the material to be processed. The comminuting operation in that case is selected such that bondable components are released during the comminuting of the coarse material pieces. The process is realized such that the generated bondable components, in general extremely fine components, act in the manner of an additive. The processing consequently can take place without having to mix in additional materials such as cement, lime, fibers, shavings, and the like. The fine components necessary for the form stabilization, drying, and/or hardening of the processed material are generated from the material to be processed itself during the comminuting of the coarse material pieces. This can be present naturally in the material to be processed in the form of chunks of rock (limestone, sand stone or other types of stone), or the coarse components can also be added just prior to realizing the processing method according to the invention to the loam/clay excavation material which does not contain such coarse material. The coarse material can furthermore also be added during the comminuting process. However, the coarse material does not represent an additive in the traditional sense because it is not bondable when used by itself and obtains this characteristic only through the comminuting and/or grinding operation in the comminuting apparatus. The coarse material travels together with the excavated earth through the comminuting apparatus. It has turned out that the process control can be selected such that a sufficiently high share of the fine material can be generated from the coarse material, despite the presence of the excavated earth or a different, corresponding mineral material with loam/clay components. This share of fine components is mixed during the comminuting operation into the clay/loam component and acts as an additive. The bonding capacity of the coarse component results from the comminuting process, in particular if the material is at least partially pulverized. However, the grinding of the coarse material can also be done separately.

A bondable additive can furthermore be added to the material to be processed (e.g. cement, lime, dusts, seeds, nuts/nut shells) preferably before or after the grinding. In that case, the amount added is considerably lower than would be required for a process without grinding of the coarse components. The ground coarse components above all are capable of absorbing water and thus increase the stability and soil-bearing capacity if the processed material is used, for example, for filling in excavated ditches, without resulting in an unacceptable post-hardening of the material. If the soil-bearing capacity of the material to be processed is achieved only by adding cement, the material will harden so strongly that a re-excavation of the ditch at a later date becomes difficult. The invention in many cases allows lowering the required amount of additive to below 0.5 weight %, wherein the admixture of an additive frequently is not even necessary. As a rule, no additional bonding agent is needed for a water content of up to 30% and a rock share of approximately 50%.

If the material to be processed is a cohesive material, meaning it contains plastic, water-containing solids such as clay or loam, then the powdered rock obtained during the comminuting operation, for example, acts in the manner of an additive. Depending on its chemical composition, the bonding properties of the powdered rock can vary, for example it can be water-absorbing. In addition, it can also have a hardening effect as a result of ion-exchanging processes or it can have a puzzolanic bonding effect. The material can furthermore have a bonding effect by absorbing water, for example if it contains anhydride components. In addition, it can form hydrate bonds as a result of micro-crystal growth. This is the case in particular if bentonite or other construction waste materials are used as coarse material. Construction waste materials of this type generally contain non-bonded components and thus have a residual bonding capacity. In addition, re-crystallization processes can furthermore lead to renewed setting after the fine grinding.

The dryness of the material can furthermore be selected such that the material can be sifted. It has turned out that rocks which may still be present can be sifted out without noticeable amounts of loam or the like adhering to them.

Comminuting apparatuses with asymmetric plates for accommodating tools are considered particularly advantageous.

Further details of advantageous embodiments of the invention can be found in the drawing, the associated description, or the dependent claims, which show in:

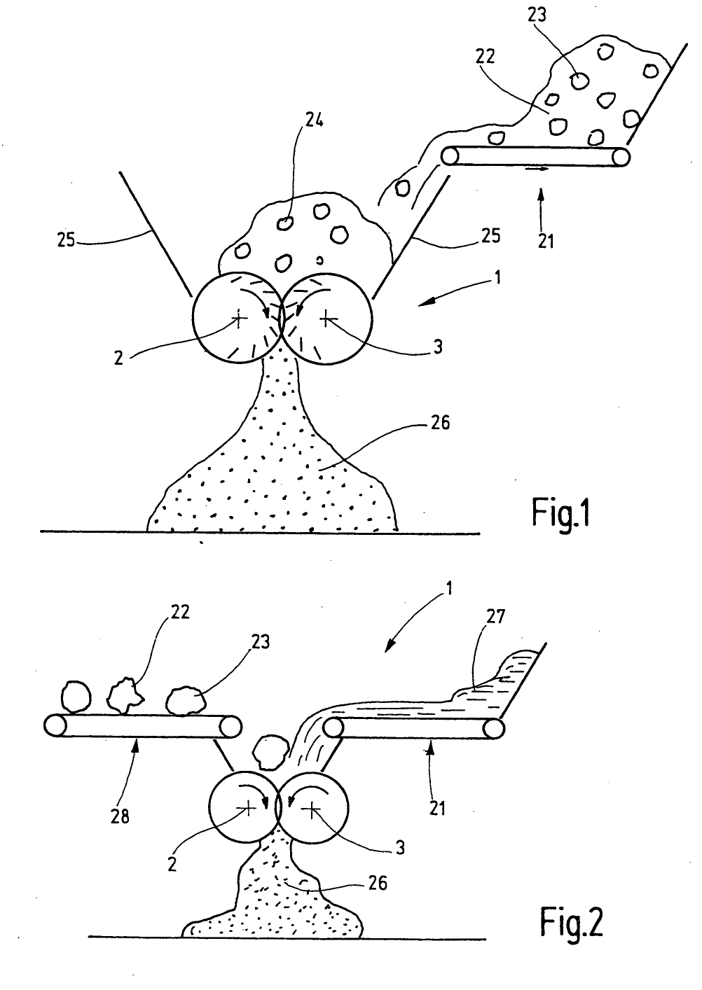

FIG. 1 A schematic sketch of the realization of the method according to the invention;

FIG. 2 Another schematic sketch showing the realization of a modified version of the method according to the invention;

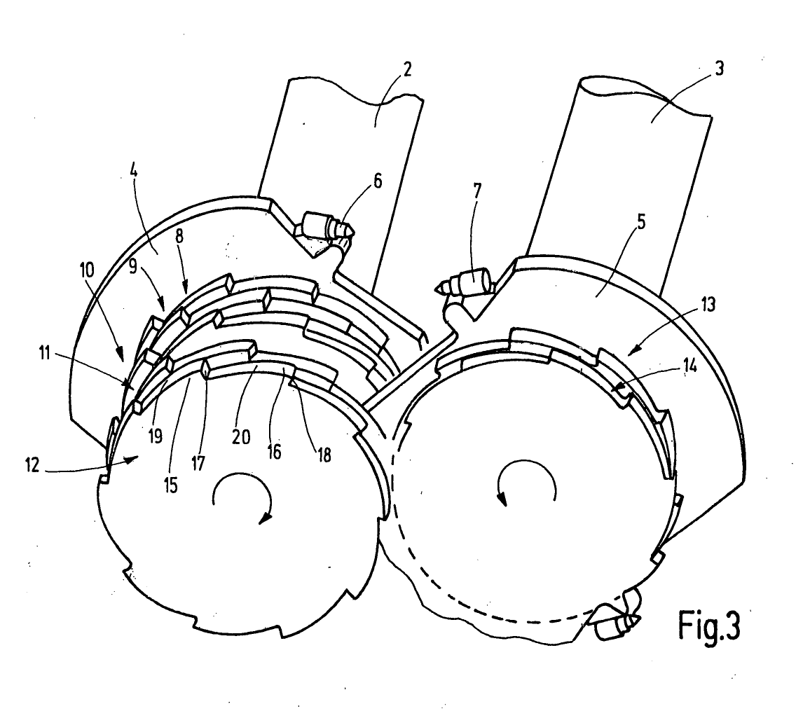

FIG. 3 A perspective view of sections of the comminuting apparatus according to FIGS. 1 or 2;

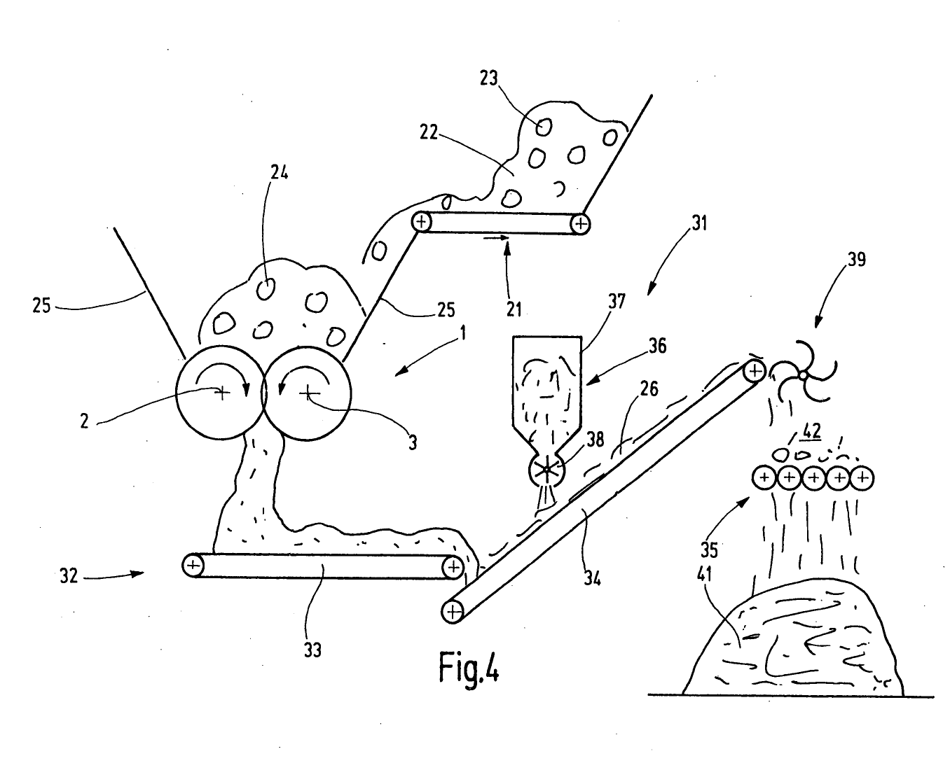

FIG. 4 A schematic representation of a modified embodiment of an apparatus for realizing the method according to the invention; and

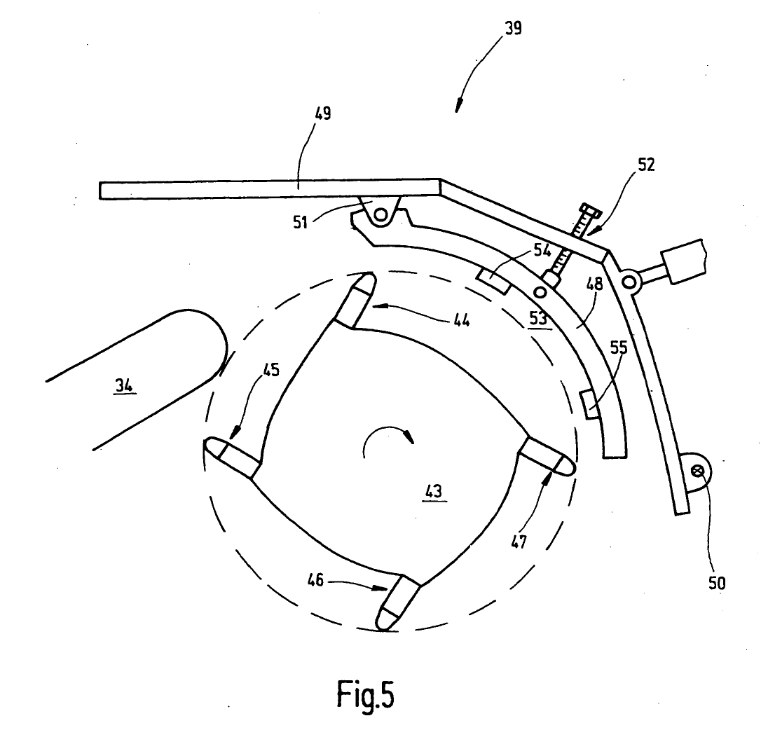

FIG. 5 A view from the side (schematically) of a mixing apparatus where the degree of post-comminuting can be selected.

FIG. 1 illustrates a comminuting apparatus 1 which functions as apparatus for comminuting, grinding, or removing interfering materials. The apparatus is provided, for example, with two counter-rotating shafts 2, 3 and thereon positioned crushing tools. The crushing tools can be designed, for example, as described in German patents 101 11 305 A1 or 202 14 956 U1. However, in contrast to these references, the crushing tools are adjusted so as to comminute at least a portion of the coarse components not only to a grain size of approximately 60 mm, but to a considerably smaller grain size. We point to FIG. 3 for the different ways in which this can be achieved. This Figure shows a perspective view of the shafts 2, 3, which are provided with axially staggered plates 4, 5, provided with recesses along the periphery in which chisels 6, 7 can be positioned. The recesses can be embodied so as to be identical or different. The chisels 6, 7 are preferably provided with conical tips which move toward each other above a plane that is defined by the two shafts 2, 3. The respectively opposing rotational directions of shafts 2, 3 are indicated with arrows in FIG. 3. Rocks picked up between the tips of chisels 6, 7 are broken apart as a result of the notching effect of the slow rotating shafts (e.g. approximately 10 to 60 rpm). Possibly existing troublesome materials (wood, steel, automobile tires) are either processed or rejected.

Otherwise, the shafts 2, 3 are tightly covered with uniformly embodied toothed disks 8 to 14, wherein differently embodied toothed disks can also be used. The teeth 15, 16 are provided with approximately radially oriented frontal areas 17, 18 in rotational direction and with back areas 19, 20 which are slanted counter to the peripheral direction. The toothed disks 8 to 14 are respectively arranged with gap, meaning adjacent toothed disks arranged on the shaft 2 respectively enclose a gap. The toothed disks on the shaft 3, which are also arranged so as to enclose a gap, respectively engage in the gaps. The number of toothed disks 8 to 14 is preferably higher than the number of plates carrying the chisels (plates 4, 5).

A mostly cylindrical pressure surface is assigned to each toothed disk on the respectively opposite side, wherein this pressure surface together with the tooth back 18, 19 of the respectively opposite-arranged toothed disk acts as a pressure gap for grinding the coarse material. However, it is also possible to arrange the toothed disks 8 to 14 on the two shafts so as to respectively fit against each other. In that case, the peripheral circles of the toothed disks 8 to 14 on the two shafts 2, 3 do not overlap. Rather, the distance is adjusted such that respectively only a small gap remains between the tooth backs of the toothed disks on both shafts 2, 3 which then functions as crushing gap.

The comminuting apparatus 1 according to FIG. 1 furthermore is provided with a device for driving the two shafts 2, 3. The driving device can be formed by two hydraulic motors, wherein respectively one of these motors is assigned to each shaft 2, 3. Both hydraulic motors can be driven by a joint diesel engine. A conveying device 21 is furthermore arranged above the comminuting apparatus 1, which supplies a material mixture 22 to the comminuting apparatus 1, schematically illustrated in FIG. 1. The material mixture 22 can be excavated earth, for example, with a loamy composition. It contains coarse material in the form of a rock-type material 23, 24 which can occur naturally in the material mixture 22 or can be randomly added in. The rock-type material 23, 24 can include brick pieces, concrete pieces, natural stone pieces (limestone, sandstone, granite, basalt, gneiss, tuff, porphyry or the like). It is also possible to use a mixture of different stones, demolition materials, road surface materials, gravel, fine gravel, sand or the like. The material mixture 22 is conveyed with the aid of the conveying system 21 to the comminuting apparatus 1 where it can be collected in a feeding funnel 25 above the comminuting apparatus 1.

During the operation of the comminuting apparatus 1, the comminuting tools supported by the shafts 2, 3 pick up the loamy, cohesive material and convey it in downward direction. The rock-type material 23, 24 is furthermore split and broken up by the chisels 6, 7 (FIG. 3). The broken pieces are then further comminuted by means of the toothed disks 8 to 14, wherein the processing is controlled to obtain a high share of fine-grained material. The comminuting of the rock material results, at least in part, in material with the consistency of flour. The resulting powdered stone (quartz powder, limestone powder, or the like) is in the process mixed directly with the loam/clay material of the material mixture 22. If this material adheres to the toothed disks 8 to 14 and thus executes revolutions, an even more intensive mixing with the resulting powdered stone occurs. As a result, a mostly homogenized, disintegrated material 26 is obtained which contains mostly ground stone, some larger pieces and still the basic loam/clay material. This material mixture can generally be reused immediate at a construction site. The amount of powdered stone generated during the comminuting operation at least results in absorbing the moisture and thus causes an immediate reduction in the stickiness and plasticity of the material. Over the long run, powdered stone materials have a tendency to harden, even when produced with the above-described grinding operation and in a moist environment. The hardening process can be the result of ion-exchanging processes, the forming of puzzolanic bonds, or of hydration processes. The material is suitable for low-porosity compacting and thus has a particularly high bearing capacity. The cohesive share of the material results in an extremely high stability of the ditch walls when filled-in ditches are excavated again or when ditches that adjoin previously filled-in ditches are excavated.

The comminuting apparatus 1 according to FIG. 2 is particularly suitable for processing the material 27 having a loam/clay type basic structure without inherent coarse components. These can be conveyed with an additional conveying device 28 to the grinding mechanism, which consists of the two shafts 2, 3 with plates 4, 5 as well as the toothed disks 8 to 14. In that case, the material 27 can be metered in together with the rock material 22, 23. The rock material 22, 23 in particular includes construction waste materials, meaning concrete chunks, brick rubbish, or other types of demolition material as well as natural rock. The rock material 22, 23 is ground in the grinding mechanism in the presence of the material 27, thus generating powdered rock which is mostly mixed homogeneously with the material 27. The resulting mixed material 26 is suitable for use at the construction site.

The system illustrated in FIG. 4 shows the same comminuting apparatus 1 as shown in FIG. 1 and described in connection with this Figure, which has been supplemented by a post-treatment apparatus 31. This apparatus includes a belt conveyor 32 with two conveying belts 33, 34 which convey the homogenized material released by the comminuting apparatus in the form of a material flow to a roller classifying screen 35. A metering device 36 is arranged above one of the conveying belts 33, 34 which can be used to feed additives, for example cement, to the material 26 positioned on the conveying belts 33, 34. The metering device 36 comprises, for example, a supply container 37 with a star feeder 38 at the outlet. Between the conveying belt 34 and the roller classifying screen 35, a conveying wheel or a post-comminuting apparatus 39 can be arranged which grips the material released by the conveying belt 34 with curved or straight prongs, arranged in radial direction, and feeds this material to the roller classifying screen 35. The roller classifying screen, in turn, is provided with a group of round or oval members rotating in the same or opposite directions, between which the fine-grain share of the deposited material passes through in downward direction. Accordingly, a material accumulation 41 is arranged below the roller classifying screen 35, as shown in FIG. 4. The coarse-grain share of the material, for example individual rocks 42 that are not ground, is moved by the roller classifying screen 35 to one side. This coarse-grained material can be supplied to a different machine for further processing.

The metering device 36 is preferably adjusted such that only small amounts of material are released, amounting to less than 0.5 weight % of the material amounts conveyed by the conveyor belts 33, 34. Also provided can be a control device which determines the metered-in amount in dependence on the residual moisture of the material 26. A respective moisture-sensing device can also be provided, but is not shown in further detail in FIG. 4. When processing mud, higher amounts can also be metered in.

The mixing device 39 with post-comminuting function, which is indicated only schematically in FIG. 4, is shown with further detail in FIG. 5. It includes a rotor 43 with preferably horizontally arranged axis of rotation which is driven by a hydraulic motor or a different power source. The rotor preferably extends over the complete width of the conveying belt 34 that is illustrated in FIG. 4. The rotor is provided along the periphery with tools, e.g. chisels 44, 45, 46, 47 which are mounted at an angle to the rotational direction, wherein tapered chisels with rounded cap are preferably used. However, other types of chisels such as flat chisels or even hammer chisels can also be used. The chisels 44 to 47 are preferably mounted rigidly, but can also be positioned so as to pivot around a pivoting axis which extends parallel to the rotational axis, in particular when using hammer chisels. For most applications, the speed of rotor 43 is adjusted to the range of 200 to 1000 rpm and preferable to a speed of 400 rpm.

The rotor 43 is assigned a cap 48 which is arranged above the rotor 43, on the side opposite the conveyor belt 34. The cap preferably covers approximately one fourth of the peripheral area of the rotor 43 and is supported on a covering hood 49 that is arranged above the rotor 43, such that it can pivot around a pivoting axis 50. A hydraulic cylinder opens and closes the covering hood 49. The rotor is fixedly connected to the conveying belt 34, for example, or to a frame which also carries the rotor 43 and the conveyor belt 34. The cap 48 is positioned pivoting by means of a corresponding bearing arrangement 51 on the supporting covering hood 49, wherein the pivoting axis is arranged above the rotor 43. The pivoting position is secured, for example, by an adjustment mechanism 52 in the form of a simple adjustment screw or also in the form of fluid-operated cylinders (hydraulic, pneumatic).

The cap 48 is curved approximately parallel to the circular trajectory traversed by the chisels 44, 45, 46, 47. Thus, it delimits together with the rotor 43 a gap-type comminuting space 53, wherein one, two or more beater bars 54, 55 can be attached to the cap 48, if necessary. These beater bars extend over the complete axial length of the rotor 43 and project in the direction of rotor 43.

During the operation, the mixing device 39 effects a further mixing and comminuting of the material supplied by the conveyor belt 34. The adjustment mechanism 52 can be used to select the desired grain size. A mostly homogeneous material is thus deposited on the roller classifying screen 35.

According to the invention, a grinding operation is used for processing excavated earth or ground, or any other type of material of an indeterminate shape, which is to be reused at a construction site, for example, or which is to be processed further or is destined for waste disposal. During this grinding operation, the respective excavated earth travels along with the coarse-material pieces through the machinery for comminuting, grinding, and removal of undesirable material. The powdered rock, obtained during the comminuting of the coarse material by means of suitable breakage and/or crushing operations, can be used as additive for the excavated earth which is generated, so-to-speak, on location. This additive is suitable for regulating the moisture content of the excavated earth or mud, as well as to effect a stabilization and hardening of same. The material becomes compact. Also possible is a granulation. The degree of drying and compacting can be adjusted through the grinding fineness, for example by grinding the coarse components to a more or less fine degree, depending on the amount of moisture or the desired degree of post-compacting. In addition, coarse components such as asphalt, construction waste materials, concrete chunks, or natural stones can be added during the comminuting operation to the excavated earth to generate the desired amount of powdered rock. The machinery for comminuting, grinding, and removing undesirable material is designed to comminute all materials which can be comminuted and prevents the passage of undesirable materials which cannot be comminuted. These materials are rejected, e.g. large steel pieces are not picked up, because they will otherwise result in blocking or reversing the machine. Any overload or one-time or multiple reversing can result in a shut-down of the machinery.

During the material processing, it is furthermore possible to add fluid, e.g. water or a watery solution, to the material during the comminuting operation as well as between the individual stages of a multi-stage comminuting operation, either before or after the comminuting. Water can be added to the mixed-in or generated fine-grain components, for example, so as to result in the setting or aid in the setting of the material. The absorption of liquid by adding pulverized dry material or the moistening of the material by adding water takes place in dependence on the starting moisture content of the material.

1. A method for processing excavated earth or other material of an indeterminate shape, wherein the material which contains crushed and/or ground coarse material is subjected to a mixing process in which the crushed coarse material is mixed together with the excavated material.

2. The method as defined in claim 1, characterized in that the coarse material pieces and/or the ground coarse material is generated during the mixing process by comminuting the coarse material present in the original material.

3. The method as defined in claim 1, characterized in that the comminuting process is realized without the addition of bondable additives.

4. The method as defined in claim 1, characterized in that the comminuting process is realized with the addition of bondable additives.

5. The method as defined in claim 4, characterized in that the amount of additives is below 1 weight %, preferably below 0.5 weight % of the total excavated material.

6. The method as defined in claim 1, characterized in that the material with indeterminate shape is a water-containing, plastic solid material.

7. The method as defined in claim 1, characterized in that the material contains water-absorbing, swelling plastic components which are sticky.

8-9. (canceled)

10. The method as defined in claim 1, characterized in that the mineral material of indeterminate shape contains the coarse material pieces.

11. The method as defined in claim 1, characterized in that the coarse material pieces are added to the material of indeterminate shape prior to the comminuting process.

12. The method as defined in claim 1, characterized in that the coarse material pieces are chunks of rock material.

13-19. (canceled)

20. The method as defined in claim 1, characterized in that the comminuting process is selected such that bondable fine components are obtained during the comminuting operation.

21. The method as defined in claim 1, characterized in that the comminuting operation is a grinding operation.

22. The method as defined in claim 1, characterized in that the comminuting operation is a crushing operation.

23. The method as defined in claim 1, characterized in that powdered rock material is generated during the comminuting operation.

24. The method as defined in claim 23, characterized in that the generated powdered rock material has the ability to bond and/or is water-absorptive.

25. The method as defined in claim 1, characterized in that the comminuted coarse material has puzzolanic bonding properties.

26. The method as defined in claim 1, characterized in that the comminuted coarse material has hydrating bonding properties.

27. The method as defined in claim 1, characterized in that the comminuted coarse material is capable of bonding due to ion exchange and/or ion-bonding.

28. The method as defined in claim 1, characterized in that the degree of crushing and/or the additives are selected such that a dry mixture which can be strained is obtained and that still existing coarse components are removed by straining.

29. An arrangement comprising a comminuting apparatus for realizing the method as defined in claim 1.

30. The arrangement as defined in claim 29, comprising a conveying device for the controlled feeding of the mineral material to the comminuting apparatus.

31. The arrangement as defined in claim 29, comprising a conveying device for the controlled feeding of coarse material to the comminuting apparatus.

32. The arrangement as defined in claim 29, characterized in that the comminuting apparatus is a crushing device.

33. The arrangement as defined in claim 29, characterized in that the comminuting apparatus has a grinding function.

34. The arrangement as defined in claim 29, characterized in that the comminuting apparatus comprises a multi-stage comminuting apparatus.

35. The arrangement as defined in claim 29, characterized in that the comminuting apparatus is provided with at least one shaft with thereon arranged plates (4, 5) which carry comminuting tools.

36. The arrangement as defined in claim 35, characterized in that in rotational direction respectively one recess is formed in front of the crushing chisels on a plate (4, 5) and that the recesses are different.

37. The method as defined in claim 1, characterized in that the material is composed of loam or contains loam.

38. The method as defined in claim 1, characterized in that the material is composed of clay or contains clay.

39. The method as defined in claim 1, characterized in that the coarse material pieces are composed of or contain limestone.

40. The method as defined in claim 1, characterized in that the coarse material pieces are composed of or contain sandstone.

41. The method as defined in claim 1, characterized in that the coarse material pieces are composed of or contain a metamorphous rock.

42. The method as defined in claim 1, characterized in that the coarse material pieces are chunks of concrete.

43. The method as defined in claim 1, characterized in that the coarse material pieces are construction waste materials.

44. The method as defined in claim 1, characterized in that the coarse material pieces are in the form of gravel or sand.

45. The method as defined in claim 1, characterized in that the coarse material pieces are pieces of asphalt, asphalt-bonded gravel, or asphalt-bonded stone chips.
